(19) United States
(12) Patent Application Publication
(10) Pub. No.: US 2024/0338977 A1
(43) Pub. Date: Oct. 10, 2024

(54) METHOD FOR DETERMINING WHETHER AN IMAGE OF A PERSON'S FACE IS SUITABLE FOR USE AS AN ID PHOTOGRAPH

(71) Applicant: Smartphone ID, Paris (FR)

(72) Inventors: Manel Ben Youssef, Massy (FR); Maïssa Diop, Bures-Sur-Yvette (FR); Sylvain Lempereur, Nieul-les Saintes (FR); Emile Menetrey, Paris (FR); Hugues Talbot, Champs-Sur-Marne (FR)

(21) Appl. No.: 18/293,630

(22) PCT Filed: Jul. 15, 2022
(86) PCT No.: PCT/FR2022/051421

§ 371 Date: Jan. 30, 2024

(30) Foreign Application Priority Data
Aug. 4, 2021 (FR) 2108488

(51) Int. Cl. G06V 40/40; G06V 10/82; G06V 40/16

(52) U.S. Cl. CPC G06V 40/40; G06V 10/82; G06V 40/166; G06V 40/172

(57) ABSTRACT

A method for determining whether an image of a person's face is suitable for use as an ID photograph comprises a step of acquiring a first image and a second image of the person's face. The method also comprises a step of propagating facial cues from the first image and facial cues from the second image into two Siamese branches of a main neural network. A computer program may be employed to implement the method, and a system may be configured to implement the method.

### CROSS-REFERENCE TO RELATED APPLICATIONS

This application is a national phase entry under 35 U.S.C. § 371 of International Patent Application PCT/FR2022/051421, filed Jul. 15, 2022, designating the United States of America and published as International Patent Publication WO 2023/012415 A1 on Feb. 9, 2023, which claims the benefit under Article 8 of the Patent Cooperation Treaty of French Patent Application Serial No. FR2108488, filed Aug. 4, 2021.

### TECHNICAL FIELD

The technical field of the present disclosure is that of processing digital images.

### BACKGROUND

An identification (ID) document typically comprises a photograph of the face of the document holder, the photograph being referred to as an “ID” photograph. In this way, it is possible to biometrically check (by means of facial recognition) the match between the ID photograph and the holder of the ID document, and therefore that the holder is actually the owner.

National authorities have defined rules for whether photographs provided by an applicant can be accepted, for such a photograph to be able to be considered an “ID” photograph. These rules depend on both the type of document and the country. For example, wearing a religious headscarf is not allowed on a French ID card, whereas this is possible in a photograph for other European countries. Similarly, the French authorities do not allow headdresses to be worn on passports and ID cards whereas other administrations allow it, such as the United Kingdom or India.

Compliance with the applicable rules can be ensured by a human operator, e.g., a professional photographer when the photograph is taken by such a professional or by a remote operator to whom the photograph was transmitted when the photograph was taken in a photo booth or by the applicant themself, which is allowed in certain countries (United Kingdom).

This verification step therefore takes time, and automation of this obligatory approval step is highly advantageous. U.S. Pat. No. 9,369,625 thus proposes a system for directly determining whether an image of the face of a person is suitable as an ID photograph, according to the requirements dictated by a given country.

However, verification that the image does indeed meet the required administrative criteria is not sufficient to provide a compliant and reliable image-taking system. The authorities want to ensure that the photographs used for creating an ID document are indeed images of real faces, in order to limit fraud, in particular, identity theft. The ID photo must also be less than six months old in some instances. The risk of fraud is particularly present when the system is fully automated.

In the field of biometric security, “face spoofing” refers to fraud that involves presenting a made-up face or a representation of a face for which recognition is expected. Thus, in the case of preparing an ID photograph, it is important to be able to detect that a photograph is indeed the face of a real person, and not a face extracted from an image or a video.

European Patent No. 2,751,739 addresses this problem and proposes multiple fraud detection methods, which implement the acquisition of two images of the face of a person. Processing is carried out to assess the flatness of the face that appears in these images and fraud is detected if a flatness score exceeds a critical threshold. However, the methods proposed by this document are complex and limited to certain categories of face spoofing, namely flat or near-flat spoofing.

Other methods are proposed in the literature to counter the problem of this type of fraud.

The article “Identity-constrained noise modeling with metric learning for face anti-spoofing” by Yaowen Xu et al., Neurocomputing 434 (2021) 149-164 discloses a method based on the modeling of the noise of a forged identity image by a learning system.

The article “CompactNet: learning a compact space for face presentation attack detection” by Lei Li et al., Neurocomputing 409 (2020) 191-207, discloses a method based on the learning of a compact color space, given that any recorded images are reproduced according to a given color space, so that face spoofing can be thwarted on the basis of the color space of a face, which will be different depending on whether it is a genuine face or a fake face image.

### BRIEF SUMMARY

One of the aims of the present disclosure is to provide an alternative solution to those of the prior art. More particularly, one aim is to provide a method and program for determining whether an image of a person's face is suitable for use as an ID photograph. This method and program are particularly simple to implement and are not limited to certain categories of face spoofing. This simplicity of implementation makes it possible to execute the method and program on a computing device that has limited computing capacity, such as a smartphone (i.e., a multi-function mobile telephone), and therefore make the ID photograph immediately available to the user.

With a view to achieving this aim, the present disclosure provides a method for detecting an attempt at identity theft by face spoofing in order to determine whether an image of a person's face is suitable for use as an ID photograph, the method comprising the following steps, implemented by a computing device:
a step of acquiring a first image and a second image of the person's face, the time elapsed between the acquisition of the first image and the acquisition of the second image being less than 5 seconds;
a cue detection step in order to respectively provide a first vector of N facial cues extracted from the first image and a second vector of N facial cues extracted from the second image;
a step of propagating the facial cues of the first vector and the facial cues of the second vector into two Siamese branches of a main neural network in order to respectively provide a first output vector and a second output vector of dimensions N;
a step of combining the first output vector and the second output vector via a cost function and establishing a numerical output measurement a evaluating the random or non-random nature of the face movement between the first image and the second image;
a step of classifying the output measurement in order to determine the random or non-random nature of the face movement and infer, as applicable, an attempt at identity theft.

According to other advantageous and non-limiting features of the present disclosure, either individually or in any technically feasible combination:
the time elapsed between the acquisition of the first image and the acquisition of the second image is between 0.1 and 2 seconds;
the cue detection step comprises identifying bounding boxes of a face that is respectively present in the first image and in the second image;
the cue detection step further comprises identifying the facial cues in the regions of the first image and of the second image that are defined by the bounding boxes;
the facial cues forming the first vector and the second vector are specific descriptors of the face;
the main neural network comprises a plurality of layers that are downstream of the two Siamese branches and form a common trunk of the main neural network, the common trunk at least partly implementing the combining step (S4);
the cost function is a contrastive loss function;
the classifying step comprises comparing the numerical output measurement with a predetermined threshold;
the method comprises a step of transforming the first vector into a first graph of facial cues and the second vector into a second graph of facial cues, the propagating step comprising the propagation of the first and of the second graphs into, respectively, the Siamese branches of the main neural network.

According to another aspect, the present disclosure provides a computer program comprising instructions suitable for implementing each of the steps of the method, when the program is executed on a computing device.

According to yet another aspect, the present disclosure provides a system for determining whether an image of a person's face is suitable for use as an ID photograph, the system comprising:
an image-taking device;
an input interface; and
a display device;
   which are connected to a computing device and to storage means, the computing device being configured to implement the method provided above.

### BRIEF DESCRIPTION OF THE DRAWINGS

Other features and advantages of the present disclosure will become apparent from the following detailed description of embodiments of the present disclosure with reference to the accompanying figures, in which:

FIG. 1 shows a schematic view of a system according to one embodiment;

FIGS. 2A and 2B respectively show, in the form of functional blocks and method steps, a computer program according to the present disclosure;

FIG. 3 shows an architecture of the branches of a main neural network according to one particular embodiment of the present disclosure;

FIG. 4 shows the progression in an optimization criterion established during the learning phase of the main neural network shown in FIG. 3; and

FIG. 5 shows the RPC graph of one exemplary implementation of the present disclosure.

### DETAILED DESCRIPTION

A system according to the various embodiments presented in this description aims to provide a user with an ID photograph in compliance with a predetermined acceptance policy. It can be provided in paper form or in digital form. It can be delivered together with a certificate of compliance, or this certificate can be incorporated via marking of the photograph. As a minimum, the system 1 aims to provide the user with an ID photograph (or a certificate) exclusively under the condition that no attempt at identity theft via face spoofing has been identified. Of course, the system 1 can apply other rules according to the nature of the ID document for which the photograph is intended or according to the applicable national regulations, as mentioned in the introduction to the present disclosure.

The ID photograph or certificate is delivered, or not delivered, in an automated manner by the system 1, using a computer program implementing an image processing method, which will be the subject of a subsequent section of this description.

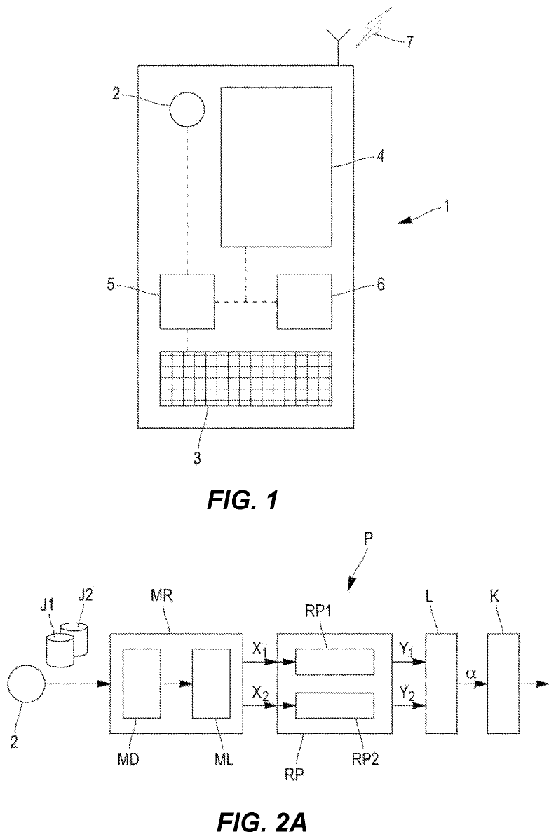

FIG. 1 shows a schematic view of a system 1 according to one embodiment. It comprises an image-taking device 2 (an image sensor or camera), an input interface 3 (e.g., a keyboard or control buttons), and a display device 4 (e.g., a screen) which are connected to a computing device 5 and to storage means 6. The system 1 can also provide other members such as e.g., a communication interface 7 for connecting the system to a computer or telecommunication network, such as the Internet.

The function of the computing device 5 and the storage means 6 is, on the one hand, to coordinate the correct operation of the other devices of the system 1 and, on the other hand, to implement the image processing method for certifying the compliance of the ID photograph.

The computing device 5 and the storage means 6 are, in particular, configured to execute an operating program of the system 1 for presenting the user, e.g., on the display device 4, with the instructions to be followed in order to obtain a photograph. The operating program collects the information or commands provided by the user using the input interface 3, e.g., the nature of the document for which the photograph is intended and/or the start command for initiating an image acquisition step by means of the image-taking device 2. The storage means allow all the data required for the correct operation of the system 1, and, in particular, the images produced by the image-taking device 2, to be stored. These means also store the operating or image processing programs, these programs conventionally consisting of instructions capable of implementing all of the processing operations and/or steps described in the present description.

The display device 4 can present the user with the images captured by the image-taking device 2 so as to allow this user to check their positioning and, more generally, their appearance before giving the system 1 the above-mentioned start command.

Of course, this FIG. 1 is purely illustrative and members other than those shown can be provided. Thus, provision can be made to equip the system 1 with a printing device in order to provide the photograph in physical form. Furthermore, the input interface 3 represented by a keyboard in FIG. 1 can be implemented by a touch-sensitive surface associated with the display device. The input interface 3 can be control buttons (which can be physical or represented virtually on the display device) that allow the user to operate the system 1, e.g., to obtain, just by pressing such a button, an ID photograph intended to be combined with a predetermined document, such as a driver's license or a passport.

After the execution of the image processing and at the end of execution of the operating program, the ID photograph, if it is indeed compliant, can be stored in the storage means 6, printed, sent to the user via the communication interface 7 and/or communicated to this user by any suitable means.

According to the chosen embodiment, the system 1 can correspond to a photo booth, to a personal or portable computer, or even just to a smartphone, i.e., a multi-function mobile telephone.

Regardless of the embodiment chosen, the user seeking to use the system 1 in order to receive an ID photograph can specify, firstly and by means of the input interface 3, the type of photograph chosen (driver's license, passport, etc.) and, optionally, the applicable national regulations, in order to allow the selection of the rules for acceptance that the ID photograph must observe. These rules can of course be predefined, in which case the preceding step is not necessary. The user positions themself appropriately facing the image-taking device 2, possibly with the help of the image reproduction acquired by this image-taking device 2 on the display device 4. The user then triggers the start command for the image-taking and image-processing sequences. Upon completion of these processing operations, and if the photograph resulting from the acquired images is indeed compliant with the selected rules, in particular, those regarding identity theft attempts, the photograph can be delivered. Of course, if such a fraud attempt is detected, the photograph is not delivered or the certificate of compliance is not granted.

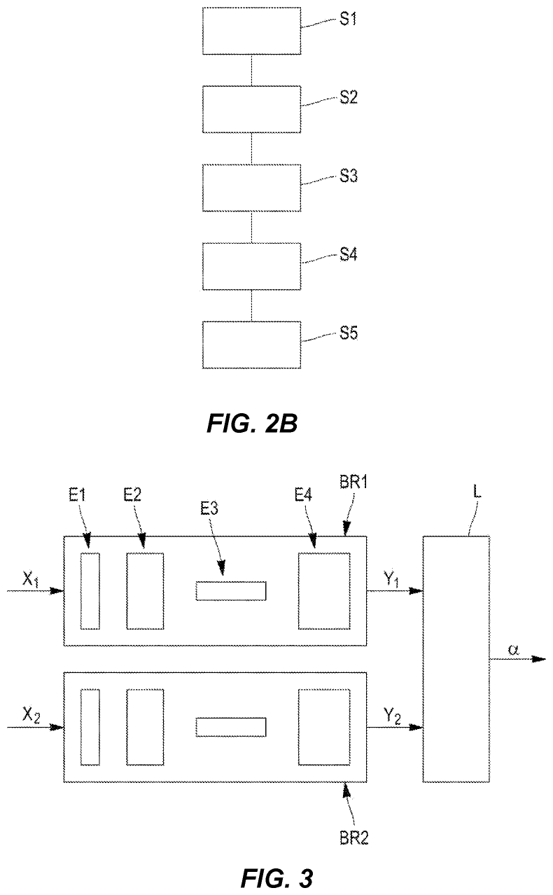

FIGS. 2A and 2B respectively show, in the form of functional blocks and method steps, the computer program P implementing the processing operations aimed at determining whether an image of the user acquired via the image-taking device 2 is able to be delivered to this user. As has already been mentioned, this program P can be held in the storage means 6 and executed by the computing device 5 of the system 1.

Prior to the execution of this program P, the system 1 acquires, in a step S1, at least a first image I1 and a second image I2 of the user's face, upon receiving the start command. The processing operation subsequently carried out by the program P aims to determine to what extent the movement of facial cues present in the first image I1 and in the second image I2 has a predictable or unpredictable nature. Specifically, it is expected that if the face shown in the images I1, I2 is not a real face (but rather a photo of a face, a mask or any other form of face spoofing) the distributions of the facial cues in, respectively, the first image I1 and the second image I2 would correlate with one another. This correlation can take the form of a regular mathematical transformation (e.g., an affine, quadratic or more complex transformation) between the facial cues in the first image I1 and the facial cues in the second image I2.

Conversely, it is expected that the distributions of the facial cues in, respectively, the first image I1 and the second image I2 would not correlate with one another when these images I1, I2 are of a real face. A user cannot effectively control the expression on their face so as to keep it fixed over time. These variations in expression are not perfectly ordered and cannot be accurately described, at the level of facial cues, by a regular transformation.

In the present disclosure, for the sake of simplicity, the expression “face movement of a random nature” refers to the situation in which the facial cues associated with two images do not correlate with one another, i.e., the images are very probably of a real face. Similarly, the expression “face movement of a non-random nature” will be used to refer to the situation in which these spatial cues do correlate, i.e., these images are very probably of a simulated face, e.g., a photo of a face or a mask.

To be completely clear, the expression “facial cues” refers to points of interest in the first image I1 and in the second image I2 that are defined by their coordinates in the image I1, I2, e.g., their pixel rows and columns. These points of interest can correspond to particular morphological features of the face (corner of the eye, of the lip, etc.) but not necessarily so. Advantageously, however, the point of interest is positioned on the face (and not in the background of the face in the image) without however necessarily corresponding to a specific morphological feature.

It will be understood that the nature of the transformations that can be applied to the facial cues between the first image of the user's face and the second image of this face in the case of an attempt at identity theft by face spoofing attack can vary depending on the nature of this attack and be complex to identify. Thus, in the context of the present disclosure, provision is made to discriminate between the random and non-random nature of face movements by learning on the basis of varied training data representative of multiple possible kinds of face spoofing.

Returning to the general description of FIGS. 2A and 2B, the computer program P therefore receives, as input, the two images I1, I2 of the person's face, which were acquired in the prior step S1 of acquisition. The time elapsed between the acquisition of the first image I1 and the acquisition of the second image I2 is less than 5 seconds, on the order of a few seconds, and typically between 0.5 and 2 seconds. This is a reasonable waiting time for the user and sufficient for a face movement of significant amplitude to have occurred while limiting this time in order to prevent any complex fraud attempt, e.g., by replacing one mask with another or one face photograph with another in the time period between the two image captures.

The two images I1, I2 are supplied, successively or simultaneously, to a cue detection module MR. The function of this computing module is to process, in a cue detection step S2, an image or a plurality of images and provide a vector of facial cues that is associated with each image supplied.

The cue detection module MR can thus comprise a first face detection computing sub-module MD, which returns the coordinates/dimensions of a bounding box for the face present in the submitted image. Such a sub-module is well known per se, and it can, in particular, implement a histogram of oriented gradient (HOG) technique or a technique based on a convolutional neural network trained for this task. This computing sub-module, regardless of the technique used, is, for example, available in pre-trained form in the “Dlib” library of computing functions.

In the context of the program P illustrated in the figures, the detection sub-module MD can be run successively on the first image I1 and on the second image I2, in order to provide, respectively, coordinates/dimensions of a first bounding box and of a second bounding box. These coordinates/dimensions can correspond to the coordinates of an angle of the box and a dimension on one side when this box is square in shape.

It should be noted that if the face detection sub-module MD does not detect any face in at least one of the images I1, I2 that are submitted thereto, it returns an indication that can be intercepted by the system 1 in order to interrupt the processing operations and inform the user of the anomaly.

The cue detection module MR can also comprise a locating sub-module ML, downstream of the face detection sub-module MD. This locating computing sub-module ML receives, as input, the information on the first and second bounding boxes provided by the detection sub-module MD as well as the first and the second images I1, I2. This information can be supplied to the sub-module MD in order to be processed successively or simultaneously by this module.

In a very general manner, this sub-module ML processes the data received as input to provide, as output, a vector of points of interest in the image, and more precisely of the portion of the image arranged in the bounding box.

According to a first type of commonly used techniques, these points of interest do not form specific descriptors of the face. These techniques can thus be SIFT (“scale-invariant feature transform”), SURF (“speeded-up robust features”), ORB (“oriented FAST and rotated BRIEF”) or any other similar technique, a detailed description of which can be found in the document “Image Matching Using SIFT, SURF, BRIEF and ORB: Performance Comparison for Distorted Images,” by Karami, Ebrahim & Prasad, Siva & Shehata, Mohamed, (2015). These techniques can be implemented using freely available computer libraries.

Used in the context of the program P, this sub-module ML simultaneously establishes a first vector X1 of points of interest arranged in the portion of the first image I1 within the first bounding box and a second vector X2 of points of interest arranged in the portion of the second image I2 within the second bounding box. The points of interest of the first vector and of the second vector are matched with one another, i.e., the same inputs of the first vector and of the second vector consist of points of interest that correspond in the first image I1 and in the second image I2.

According to one alternative approach, the points of interest are specific descriptors of the face (corner of the mouth, of the eye, of the nose, etc.). This approach can be implemented by a neural network trained to identify these specific descriptors in an image (in this case a portion of the first image I1 and/or of the second image I2). Such a neural network is also available in the Dlib library cited above. The points of interest of the first vector and of the second vector provided according to this alternative approach are also matched with one another.

The points of interest of images identified by the various techniques presented above form, in the context of the present disclosure, facial cues on the faces shown in the processed images. Typically, the choice is made to configure the locating sub-module ML to identify a number N of points of interest/facial cues that is between 20 and 200, and more particularly between 60 and 90.

Regardless of the approach adopted in order to implement this locating computing sub-module ML, the latter delivers, as output, a first vector X1 of N facial cues extracted from the first image I1 and a second vector X2 of N facial cues extracted from the second image I2. These matched first and second vectors X1, X2 also form the outputs of the cue detection module MR.

Continuing the description of FIGS. 2A and 2B, the computer program P comprises, downstream of the cue detection module MR, a main neural network RP formed of two Siamese branches. In a very general manner and as is well known per se, a neural network consists of layers of neurons that are interconnected according to a given architecture, and each neuron of each layer is defined by neuron parameters, which collectively form the learning parameters of the network. In the main neural network RP, the two branches RP1, RP2 are themselves neural networks that have exactly the same architecture and the same learning parameters. This is why these two branches are referred to as “Siamese.”

As can be seen in FIG. 2A, the first vector X1 is applied to the input of the first branch BR1 of the main neural network RP. Similarly, the second vector X2 is applied to the input of the second branch BR2 of this network RP. The first branch delivers a first output vector Y1 composed of N scalar values, and therefore defining a point in a vector space of dimension N. The second branch BR2 delivers a second output vector Y2, which is also composed of N scalar values.

The main neural network RP1 was trained and configured to separate the two output vectors Y1, Y2 into separate areas of the vector space when the two images I1, I2 with which these vectors are associated exhibits a random face movement, i.e., when the faces shown in the two images I1, I2 appear to be real. At the same time, the main neural network RP is configured to group two output vectors Y1, Y2 together in the same area of the vector space when the two images I1, I2 with which these vectors are associated exhibits a non-random face movement, i.e., when the faces shown in the two images I1, I2 do not appear to be real, which is indicative of an attempt at identity theft by face spoofing.

It should be noted that reverse operation can of course be chosen (i.e., grouping two output vectors together in the same area of the vector space corresponding to a random face movement situation and separating the two output vectors into different areas in the opposite case), the important thing being to attempt to discriminate between the two, random and non-random, face movement situations by grouping the output vectors together in the same area or by separating them into separate areas as the case may be.

Regardless of the solution adopted, the processing operations leading to the transformation of the first facial cue vector X1 and the second facial cue vector X2 extracted from the first and second images I1, I2 into first and second output vectors Y1, Y2 implemented by the main neural network RP form a propagating step S3.

In one specific example presented at the end of the present description, an architecture common to the two branches BR1, BR2 will be illustrated, but in general this architecture is formed of a sequence of purely convolutional and activation layers, allowing spatial relationships to be identified between the facial cue vectors.

In one particularly advantageous variant, it is possible to supplement the main neural network RP, downstream of the two branches, with a small number of fully connected layers of decreasing dimension, forming a common trunk of the neural network, and making it possible to prepare for decision-making. In such a variant, the output vectors Y1, Y2 do not form outputs of the main neural network RP as such, but rather an intermediate state of this network that supplies the layers of the common trunk. The last layer thereof prepares a combined output vector Z, which combines the two vectors Y1, Y2. This combined output vector Z can have any dimension, which can, in particular, be different from those of the output vectors Y1, Y2 and even correspond to a simple scalar value. Of course, the common trunk portion of the main network is run simultaneously and with the same training data as the two branches BR1, BR2.

To finish the description of the functional diagram of the program P of FIGS. 2A, 2B, this program P also comprises, downstream of the main neural network RP, a cost block 1, which combines the first output vector Y1 and the second output vector Y2 via a cost function, and delivers a numerical output value a, which seeks to numerically evaluate the random or non-random nature of face movement between the first image I1 and the second image I2.

When the main neural network RP comprises the common trunk portion, as presented above, the cost block L processes the combined output vector Z in order to provide this numerical value. When the combined output vector Z is summarized as a simple scalar, the cost block L is then considered to be entirely integrated into the main neural network RP, and the scalar value delivered by this network RP constitutes the numerical output value a that seeks to numerically evaluate the random or non-random nature of face movement.

This numerical value, which can be between 0 and 1, for example, could be said to measure the “distance” separating the two output vectors Y1, Y2. The cost function implemented by the cost block L can correspond to any suitable function, e.g., a contrastive loss function, as is well known per se. In any case, the processing operations implemented by the cost block L are executed during a combining step S4 of the method.

Lastly, the program P comprises a module K for classifying the output measurement a in order to determine, on the basis of this measurement, the random or non-random nature of the face movement and infer, as applicable, an attempt at identity theft. The classifying step S5 implemented by this module K can comprise comparing the numerical measurement a with a predetermined threshold, which makes it possible to conclude, depending on whether the numerical measurement a is greater than or less than this predetermined threshold, whether or not a fraud attempt has taken place.

The information provided by the classification module concludes the execution of the image processing program, and this information can therefore be used by the operating program of the system 1 to validate, or otherwise, the compliance of the images I1, I2 and provide, or otherwise, an ID photograph, which can correspond to the first or second image I1, I2.

It should be noted that the image processing implemented by the program P is not limited to that described and shown in FIG. 2. It is thus possible to make provision for this program P to carry out other processing operations on at least one of the images I1, I2, e.g., in order to identify therein an non-compliant object (e.g., glasses, headdress) or make them compliant (background uniformity, red-eye removal) or even retouch the images, e.g., make the non-compliant objects optionally identified therein disappear; this for the minor retouches that are accepted by the authority delivering the ID documents.

### Variant Based on Graph Neural Networks

In one variant embodiment, the cue detection module MR is completely identical to that of the main embodiment. It therefore prepares a first vector X1 of N facial cues extracted from the first image I1 and a second vector X2 of N facial cues extracted from the second image I2.

Following this locating step, the vectors X1, X2 are delivered to an additional module, which aims to transform each vector X1, X2 into a graph to allow the face to be described with greater precision. This graph is thus constructed by associating each input of a vector (a facial cue) with a list of other inputs (other facial cues) connected thereto.

For example, a facial cue associated with the left corner of the lip is connected to the facial cues associated with the mid-points of the lips, with the base of the left wing of the nose, and with the horizontal projection of the left corner of the mouth on the oval of the face.

In one alternative approach for forming the graph that does not rely on facial cues corresponding to morphological elements of the face, each input of a vector (a facial cue from the image) can be connected to the k other neighboring inputs (the k closest facial cues in the image), k being able to be chosen to be typically between 3 and 10.

In this way, it is possible to describe the shape of the face as consecutive points all connected to one another. This graph-based or “graph” approach makes it possible to provide information on correlation between the facial cues, in addition to the information on the positions and distances between the facial cues, this information being made available in the vector representation of the main embodiment.

This graph is then propagated within a Siamese neural network, wherein each branch is formed of a neural network of graphs, a detailed description of which can be found in the document “Neural Network for Graphs: A Contextual Constructive Approach,” by Micheli, Alessio, (2009).

What makes this variant special is that it allows the quality of the predictions to be reinforced by adding information that can be calculated rapidly, while using a neural network adapted for the comparison of data.

Following propagation within the Siamese network, the results from the two branches of the neural network are compared within the cost block 1, which value will then be inserted into the classification module K in order to determine, like in the main embodiment, whether the user has attempted to carry out a genuine acquisition or has attempted fraud.

### EXAMPLE

As an illustration of the program P and the image processing method presented above, FIG. 3 shows one particular architecture of the branches BR1, BR2 of the main neural network RP. This architecture comprises, connected to one another consecutively:
An input layer E;
A first fully connected layer E2;
A spreading layer E3; and
A second fully connected layer E4.

The first and second fully connected layers are followed by a rectified linear unit (ReLu) on each of their outputs (not shown in the figure).

The facial cue vectors X1, X2 are formed of 81 coordinates of points of interest on the faces, which are determined using the functions available in the Dlib library. The cost block implements a contrastive loss function.

This architecture combined with the cost block 1 was trained using a set of data composed of 1075 pairs of images of a real face, and 254 pairs of images representative of an attempt at identity theft by face spoofing. This set of data was divided into two portions; 60% of each category were used during the training of the main neural network, and the remaining 40% were used to evaluate the accuracy of fraud detection.

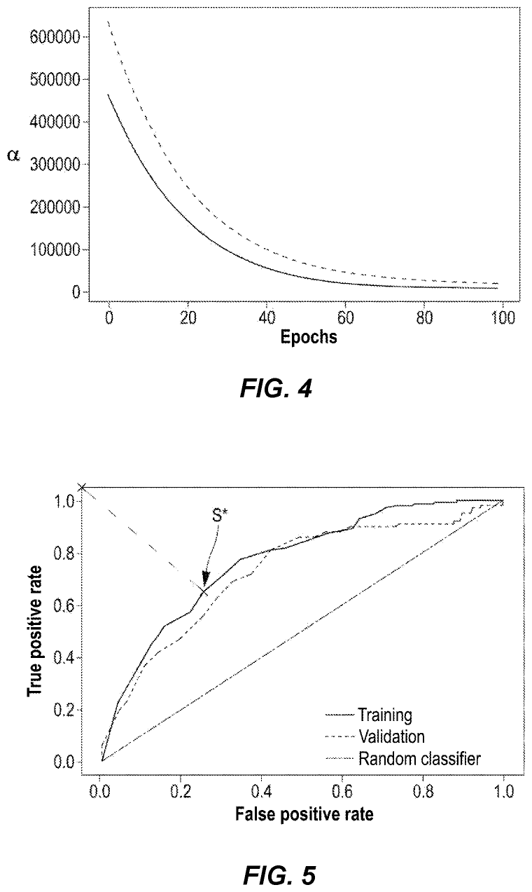

The main neural network used by way of example was trained using training data over 100 epochs, using an Adam optimizer and a learning parameter of 10-6. FIG. 4 shows the progression in the optimization criterion established during this learning phase. It can be seen that this progression converges whether measured on learning data or on validation data.

The curve of FIG. 5 is the ROC (receiver operating characteristic) curve for this example. The graph shows the performance of the program P and of the processing method according to the value selected for the threshold in the classification module K. The x-axis of the graph shows the proportion of false positives, and the y-axis shows the proportion of true positives. In this graph, the optimal coordinate point (0.1), i.e., that with 0% false positives and 100% true positives, is targeted. The graph of FIG. 5 shows the performance of this example according to the value selected for the threshold for the classification module. It also makes it possible to select the value of this threshold S* that makes it possible to be as close as possible to the optimal coordinate point (0.1).

Naturally, the present disclosure is not limited to the embodiments described, and it is possible to add alternative embodiments without departing from the scope of the invention as defined by the claims.

1. A method for detecting an attempt at identity theft by face spoofing to determine whether an image of the face of a person is suitable for use as an ID photograph, the method comprising the following steps, implemented by a computing device:
a step of acquiring a first image and a second image of the face of the person, the time elapsed between the acquisition of the first image and the acquisition of the second image being less than 5 seconds;
a cue detection step to respectively provide a first vector of N facial cues extracted from the first image and a second vector of N facial cues extracted from the second image;
a step of propagating the facial cues of the first vector and the facial cues of the second vector into two Siamese branches of a main neural network in order to respectively provide a first output vector and a second output vector of dimensions N;
a step of combining the first output vector and the second output vector via a cost function and establishing a numerical output measurement evaluating the random or non-random nature of the face movement between the first image and the second image; and
a step of classifying the numerical output measurement to determine the random or non-random nature of the face movement and infer the presence or absence of an attempt at identity theft.

2. The method of claim 1, wherein the time elapsed between the acquisition of the first image and the acquisition of the second image is between 0.1 and 2 seconds.

3. The method of claim 1, wherein the cue detection step comprises identifying bounding boxes of a face that is respectively present in the first image and in the second image.

4. The method of claim 3, wherein the cue detection step further comprises identifying the facial cues in the regions of the first image and of the second image that are defined by the bounding boxes.

5. The method of claim 1, wherein the facial cues forming the first vector- and the second vector are specific descriptors of the face.

6. The method of claim 1, wherein the main neural network comprises a plurality of layers downstream of the two Siamese branches, the plurality of layers forming a common trunk of the main neural network, the common trunk at least partly implementing the combining step.

7. The method of claim 1, wherein the cost function is a contrastive loss function.

8. The method of claim 1, wherein the classifying step comprises comparing the numerical output measurement with a predetermined threshold.

9. The method of claim 1, further comprising a step of transforming the first vector into a first graph of facial cues and the second vector into a second graph of facial cues, the propagating step comprising the propagation of the first and of the second graphs into, respectively, the Siamese branches of the main neural network.

10. A non-transitory computer-readable media storing instructions thereon that, when executed on a computing device, cause the computing device to perform a method comprising the following steps:
a step of acquiring a first image and a second image of the face of the person, the time elapsed between the acquisition of the first image and the acquisition of the second image being less than 5 seconds;
a cue detection step to respectively provide a first vector of N facial cues extracted from the first image and a second vector of N facial cues extracted from the second image;
a step of propagating the facial cues of the first vector and the facial cues of the second vector into two Siamese branches of a main neural network in order to respectively provide a first output vector and a second output vector of dimensions N;
a step of combining the first output vector and the second output vector via a cost function and establishing a numerical output measurement evaluating the random or non-random nature of the face movement between the first image and the second image; and
a step of classifying the numerical output measurement to determine the random or non-random nature of the face movement and infer the presence or absence of an attempt at identity theft.

11. A system for determining whether an image of a face of a person is suitable for use as an ID photograph, the system comprising:
an image-taking device;
an input interface; and
a display device;
which are connected to a computing device and to a data storage, the computing device configured to implement a method comprising the following steps:
a step of acquiring a first image and a second image of the face of the person, the time elapsed between the acquisition of the first image and the acquisition of the second image being less than 5 seconds;
a cue detection step to respectively provide a first vector of N facial cues extracted from the first image and a second vector of N facial cues extracted from the second image;
a step of propagating the facial cues of the first vector and the facial cues of the second vector into two Siamese branches of a main neural network in order to respectively provide a first output vector and a second output vector of dimensions N;
a step of combining the first output vector and the second output vector via a cost function and establishing a numerical output measurement evaluating the random or non-random nature of the face movement between the first image and the second image; and
a step of classifying the numerical output measurement to determine the random or non-random nature of the face movement and infer the presence or absence of an attempt at identity theft.
